(19) United States
(12) Patent Application Publication
(10) Pub. No.: US 2008/0079254 A1
(43) Pub. Date: Apr. 3, 2008

(54) Seat belt retractor and seat belt apparatus

(75) Inventors: Hayato Uchibori, Minato-ku (JP); Kazuyoshi Tsuruta, Minato-ku (JP)

Correspondence Address: KANESAKA BERNER AND PARTNERS LLP, 1700 DIAGONAL RD, SUITE 310, ALEXANDRIA, VA, 22314-2848, US

(73) Assignee: TAKATA CORPORATION, Tokyo (JP)

(21) Appl. No.: 11/902,240

(22) Filed: Sep. 20, 2007

(30) Foreign Application Priority Data
Oct. 3, 2006 (JP) 2006-271982

(51) Int. Cl. B60R 22/353

(52) U.S. Cl. 280/807; 242/382.1; 242/389

(57) ABSTRACT

A seat belt retractor includes a winding device for winding and unwinding a webbing by rotation and a winding state detection mechanism for detecting the winding state of said webbing onto the winding device. The winding state detecting mechanism includes a first gear which is connected to a rotary shaft of the winding device; a second gear which has a large-diameter gear portion meshing with the first gear and a small-diameter gear portion having a number of teeth smaller than that of the large-diameter gear portion; a ring cam which is provided with an internal gear portion, formed in the inner periphery thereof, meshing with the small-diameter gear portion of the second gear and is also provided with a cam portion formed in the outer periphery thereof; and a signal output device which receives a cam action of the ring cam to output a signal.

### BACKGROUND OF THE INVENTION AND RELATED ART STATEMENT

The present invention relates to a seat belt retractor for winding and unwinding a webbing in a seat belt apparatus and, more particularly, relates to a seat belt retractor provided with a winding state detecting mechanism for detecting the winding state of a webbing and to a seat belt apparatus comprising the same.

A seat belt apparatus is a necessary apparatus for a seat of a vehicle such as a high-speed moving vehicle for protecting an occupant (seat belt wearer) by restraining the occupant from moving rapidly due to abrupt acceleration generated by a collision with a vehicle or the like. Such seat belt apparatus comprises a webbing (seat belt), a seat belt retractor, and a buckle device as main components.

The seat belt retractor has a rotatable winding device generally called a spool on which the webbing is wound up by some force such as spring force so as to retract the webbing. The wearing of the webbing to the occupant is achieved by pulling a tongue plate disposed on the webbing to unwind the webbing from the winding device so as to withdraw the webbing from the seat belt retractor and latching the tongue plate with the buckle device placed on a side of the seat.

In some of such seat belt apparatuses, it is detected whether or not the occupant wears in a predetermined state, that is, the wearing of the webbing by the occupant is detected. In case of conventional seat belt apparatuses, the webbing wearing detection is normally carried out by a buckle detection system. This means that the buckle device is provided with a suitable detecting device to detect latching of the webbing with the buckle device. The system in which the wearing of the webbing of the occupant is detected by the latching is conventionally and generally used.

By the way, in vehicles as main application object of seat belt apparatuses, recently, there is a tendency for the seat arrangement to be diversified. In response to this tendency, demand for a webbing wearing detection system is increased as an alternative to the buckle detection system because the webbing wearing detection by the buckle detection system has a problem that a harness for the buckle detection system is sometimes caught by a seat or the like when vehicle seats are rearranged.

As a webbing wearing detection system as an alternative to the buckle detection system, a retractor detection system using a seat belt retractor can be listed. That is, the seat belt retractor is provided with a function of detecting the winding state of the webbing. As a result, the seat belt retractor can detect whether or not a necessary amount of webbing for an occupant to wear the webbing is unwound, thereby detecting the wearing of the webbing.

It has been conventionally known to detect the winding state, especially, the winding amount of a webbing by a seat belt retractor. Various techniques have been proposed for such detection. Examples are techniques disclosed in Patent document 1 (Japanese Unexamined Patent Application Publication No. 9-82171) and Patent document 2 (Japanese Unexamined Patent Application Publication No. 2-18136). These techniques are typical ones among winding amount detecting techniques for a seat belt retractor of a type in which a webbing is retracted by spring force, i.e. a spring-driven-type seat-belt retractor.

In the technique disclosed in Patent document 1, the winding amount of a webbing is detected by the diameter of a winding roll of the webbing wound onto a winding shaft (winding device). Specifically, a seat belt winding amount detection switch is arranged to closely contact the outer periphery of the roll of the webbing wound onto the winding shaft. By the switch, the winding amount of the webbing is detected by detecting the diameter of the roll of the webbing.

On the other hand, in the technique disclosed in Patent document 2, the rotation amount of a winding device is detected, thereby detecting the winding amount of the webbing. To detect the winding amount of the webbing from the rotation amount of the winding device, a reduction mechanism for suitably reducing the revolution of the winding device is required. In the technique disclosed in Patent document 2, a reduction mechanism comprises a rotation plate attached to a retractor shaft (rotary shaft of winding device), two planetary gears attached to the rotation plate, a fixed internal gear which meshes with the planetary gears, and a rotatable internal gear which also meshes with the planetary gears. Based on the rotation amount of the retractor shaft of which revolution is reduced by the reduction mechanism, i.e. the rotation amount of the rotatable internal gear, the winding amount of the webbing is detected.

The retractor detection system for webbing wearing detection has a detection reliability (detection accuracy) problem and a cost problem. In terms of the detection reliability, the winding diameter detection method in which the winding state of the webbing is detected from the diameter of the roll of wound webbing as the technique of Patent document 1 is insufficient. That is, the roll of the wound webbing by the winding device is not always a perfect circle and the thickness of the webbing varies due to tension. This means that the diameter of the roll of the wound webbing does not accurately correspond to the winding state of the webbing so that the winding diameter detection method remains to have a detection reliability problem.

On the other hand, the rotation amount detection method in which the winding state of the webbing is detected from the rotation amount of the winding device as the technique of Patent document 2 achieves more reliable detection. In the rotation amount detection method of Patent document 2, however, the reduction mechanism for detecting the winding amount comprises a rotation plate, two planetary gears, a fixed internal gear, and a rotatable internal gear as mentioned above, that is, the reduction mechanism requires a large number of parts and complex structure so that it remains to have a cost problem.

The present invention was made in view of the above situation, and the object of the present invention is to provide a seat belt retractor and a seat belt apparatus which enable high accuracy detection of the winding state of the webbing for detecting the wearing of the webbing and allow a mechanism for the detection to be manufactured at low cost.

Further objects and advantages of the invention will be apparent from the following description of the invention.

### SUMMARY OF THE INVENTION

A seat belt retractor of the present invention achieving the aforementioned object comprises a winding device for winding and unwinding a webbing by rotation and further comprises a winding state detection mechanism for detecting the winding state of said webbing onto said winding device, wherein said winding state detecting mechanism includes a first gear which is connected to a rotary shaft of said winding device; a second gear which has a large-diameter gear portion meshing with said first gear and a small-diameter gear portion of which the number of teeth is smaller than that of said large-diameter gear portion; a ring cam which is formed in a ring-like shape and is provided with an internal gear portion, formed in the inner periphery thereof, meshing with the small-diameter gear portion of said second gear and is also provided with a cam portion formed in the outer periphery thereof; and a signal output device which receives a cam action of said ring cam to output a signal.

The seat belt retractor of the present invention as mentioned above enables high accuracy detection of the winding state of the webbing because the detection is based on the rotation amount of the winding device and allows the reduction mechanism in the winding state detection mechanism to be composed of a smaller number of parts, i.e. the first and second gears and the ring cam, thereby achieving low cost structure.

Furthermore, the present invention provides a seat belt retractor as mentioned above, wherein said winding state detection mechanism has an unwound amount detecting device for detecting the unwound amount of said webbing, and said signal output device outputs a signal according to a detection result of said unwound amount detecting device.

This enables the detection of the unwound amount of the webbing. As a result, in case that unwound amounts of the webbing according to age (or sex, physique) are previously set, the wearer (age, sex, or physique) can be detected when the webbing is unwound by one of the unwound amounts previously set.

The present invention also provides a seat belt retractor as mentioned above, further comprising an ALR mechanism for locking said webbing from being unwound after said webbing is unwound by a predetermined amount, wherein the first gear, the second gear, and the ring cam of said winding state detection mechanism also function as components of said ALR mechanism.

Since the mechanical element of the ALR mechanism, which is generally required in the seat belt retractors, is used also as a mechanical element of the reduction mechanism in the winding state detection mechanism, the number of parts as the entire seat belt retractor can be significantly reduced, thereby achieving further low cost structure. This is an efficient use of characteristics of the ALR mechanism. More specifically, the ALR mechanism is normally structured to detect the unwinding of the webbing by its mechanical mechanism and to lock the webbing from being unwound when the webbing is unwound by a predetermined amount. By using the function of detecting the unwinding of the webbing of the ALR mechanism for the winding state detection mechanism, the mechanical element can be shared for the ALR mechanism and the winding state detection mechanism, thereby achieving significant reduction in the number of parts as the entire seat belt retractor.

Furthermore, the present invention provides a seat belt retractor as mentioned above, wherein said signal output device is a switch operated by the first gear, the second gear, and the ring cam as the components of said ALR mechanism.

Accordingly, the detection of the winding state of the webbing is conducted based on the rotation amount of the winding device by means of the first gear, the second gear, and the ring cam, and the detection result is output by the switch. This enables high accuracy detection of the winding state of the webbing for the detection of wearing of the webbing, yet achieving reduction in the number of parts.

A seat belt apparatus of the present invention achieving the aforementioned object comprises: a seat belt retractor as in the first aspect through the forth aspect of the present invention; a webbing to be wound and unwound by the seat belt retractor; a tongue disposed on the webbing; and a buckle device to be latched by the tongue.

A vehicle occupant detection device of the present invention achieving the aforementioned object is a vehicle occupant detection device for detecting whether or not a vehicle occupant wears a seat belt, comprising: a winding device for winding and unwinding a webbing by rotation; and a winding state detection mechanism for detecting the winding state of said webbing onto said winding device, wherein said winding state detecting mechanism includes a first gear which is connected to a rotary shaft of said winding device; a second gear which has a large-diameter gear portion meshing with said first gear and a small-diameter gear portion of which the number of teeth is smaller than that of said large-diameter gear portion; a ring cam which is formed in a ring-like shape and is provided with an internal gear portion, formed in the inner periphery thereof, meshing with the small-diameter gear portion of said second gear and is also provided with a cam portion formed in the outer periphery thereof; and a signal output device which receives a cam action of said ring cam to output a signal.

According to the present invention as mentioned above, a seat belt retractor which is adapted to detect the winding state of the webbing for detecting the wearing of the webbing is improved to detect the winding state with a high degree of accuracy and allow a mechanism for the detection to be manufactured at low cost.

### BRIEF DESCRIPTION OF THE DRAWINGS

FIG. 1 is an illustration showing an example of the entire structure of a seat belt apparatus provided with a seat belt retractor according to an embodiment of the present invention.

FIG. 2 is an illustration showing the outer configuration of the seat belt retractor taken from one side thereof.

FIG. 3 is an illustration showing the outer configuration of the seat belt retractor taken along an arrow A in FIG. 2.

FIG. 4 is an illustration showing the internal structure of a mechanism housing.

FIG. 5 is an illustration showing a second gear taken from one side thereof.

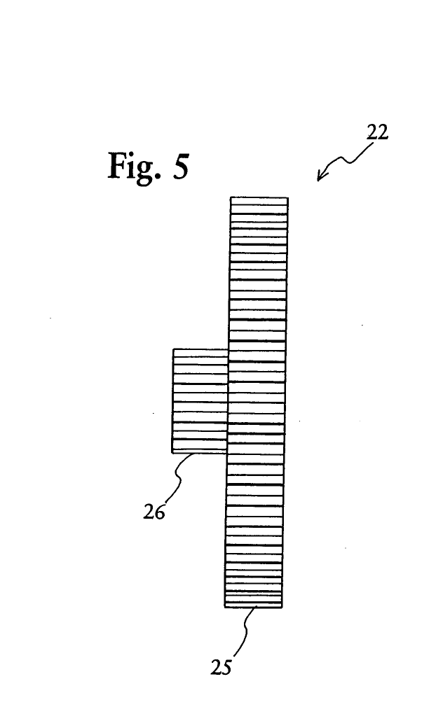

### DETAILED DESCRIPTION OF PREFERRED EMBODIMENTS

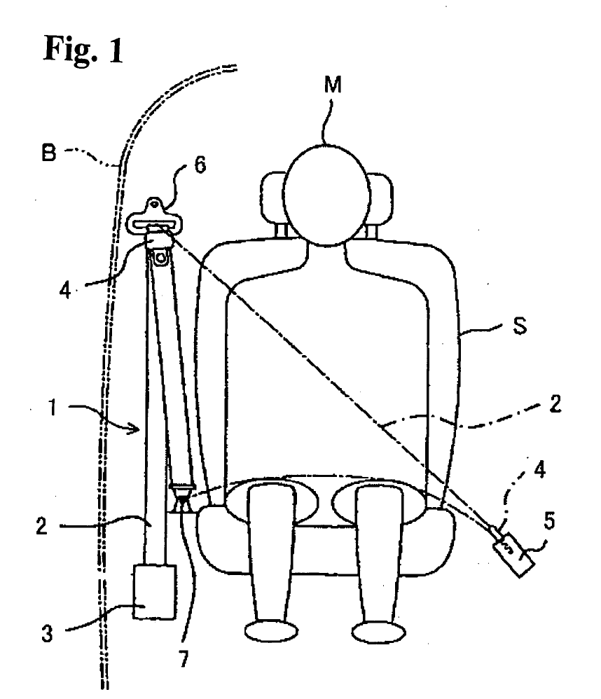

Hereinafter, an embodiment of the present invention will be described with reference to drawings. FIG. 1 shows the entire structure of a seat belt apparatus provided with a seat belt retractor according to an embodiment of the present invention. The seat belt apparatus 1 of this embodiment is installed to a vehicle seat S for restraining a vehicle occupant M to the seat S and comprises a webbing 2, a seat belt retractor 3 (occupant detection device), a tongue 4, a buckle device 5, a deflection fitting 6, and an anchor 7.

The one side of the webbing 2 is wound up by the seat belt retractor 3 such that the webbing 2 is allowed to be withdrawn, the other side end of the webbing 2 is pivotally connected to a vehicle body B by the anchor 7, and the middle portion of the webbing 2 is inserted through the deflection fitting 6. The wearing of the webbing 2 to the occupant M is achieved by pulling the tongue 4 slidably disposed on the webbing 2 to withdraw the webbing 2 from the seat belt retractor 3 and latching the tongue 4 with the buckle device 5, thereby obtaining a state capable of restraining the occupant M by the webbing 2.

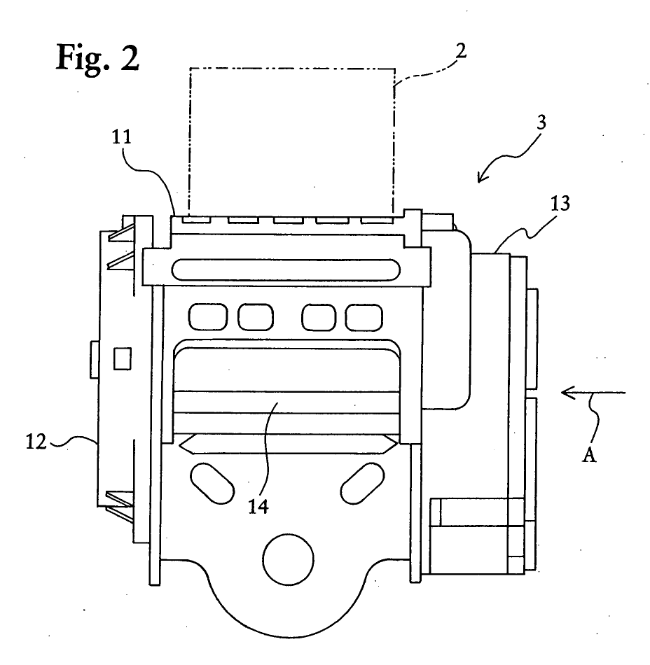

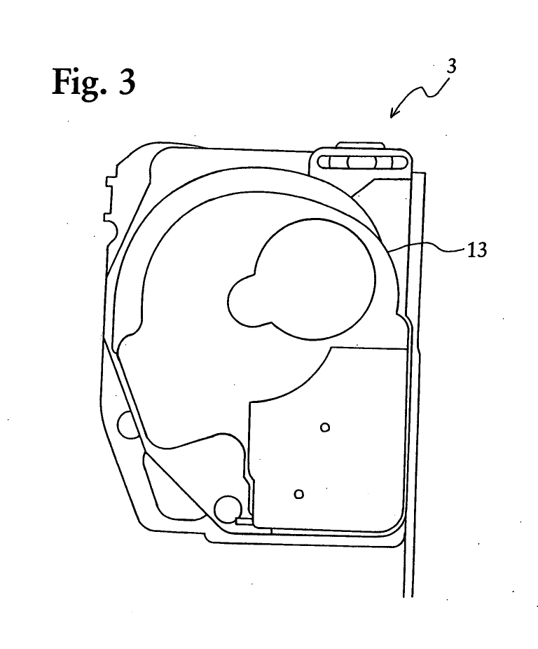

The main mechanical element of the seat belt apparatus 1 is the seat belt retractor 3. FIG. 2 and FIG. 3 show the entire outer configuration of the seat belt retractor 3, wherein FIG. 2 shows the outer configuration of the seat belt retractor 3 taken from one side and FIG. 3 shows the outer configuration of the seat belt retractor 3 taken along an arrow A shown in FIG. 2.

The seat belt retractor 3 comprises a spool housing 11, a spring housing 12, and a mechanism housing 13. In the spool housing 11, a spool 14 as winding device for winding and unwinding the webbing according to its rotation is accommodated. The spool 14 is biased in a webbing winding direction by a return spring (not shown) accommodated in the spring housing 12. The spool 14, the return spring, and peripheral elements around them may be conventionally well known ones. Therefore, the description about them will be omitted.

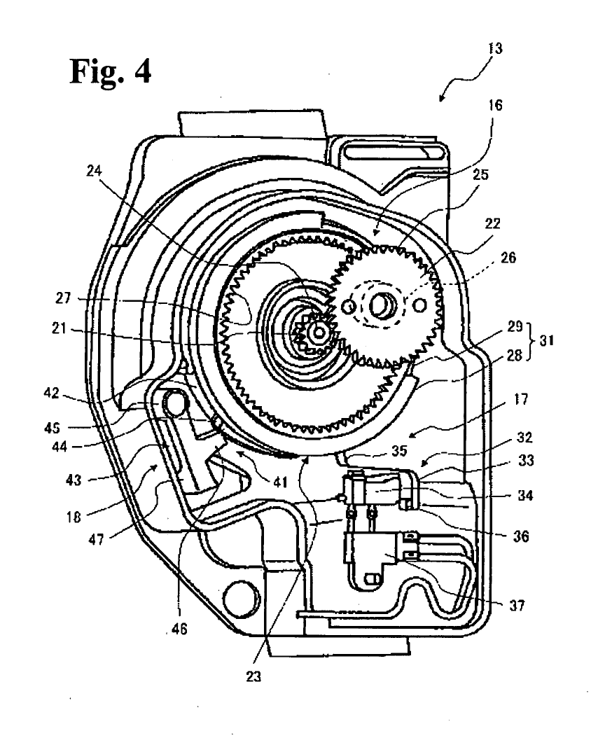

FIG. 4 shows an internal structure of the mechanism housing 13. In the mechanical housing 13, a reduction mechanism 16 for taking the rotation of the spool 14 after reducing the revolution is accommodated. In addition, a winding state detection mechanism 17 and an ALR (Automatic Locking Retractor) mechanism 18 which share the reduction mechanism 16 as their main mechanical element are accommodated.

The reduction mechanism 16 includes a first gear 21, a second gear 22, and a ring cam 23 and is adapted to reduce the revolution of the spool 14 at a predetermined reduction ratio to take the rotation as the rotation of the ring cam 23.

The first gear 21 is a pinion gear in which the number of teeth is Z₁ and the pinion gear is directly connected to a rotary shaft 24 of the spool 14. Specifically, the first gear 21 is fitted onto the rotary shaft 24 so that the first gear 21 rotates at the same revolution, i.e. a reduction ratio of 1, as the rotary shaft 24.

The second gear 22 comprises a large-diameter gear portion 25 in which the number of teeth is Z₂ larger than the number of teeth Z₁ and a small-diameter gear portion 26 in which the number of teeth is Z₃ smaller than the number of teeth Z₂. The large-diameter gear portion 25 is meshed with the first gear 21 so that the second gear 22 rotates at a reduction ratio of Z₁/Z₂ relative to the gear 21 according to the rotation of the first gear 21.

The ring cam 23 is formed in a ring-like shape and is provided with an internal gear portion 27, formed in the inner periphery thereof, in which the number of teeth is Z₄ larger than the number of teeth Z₃, and the internal gear portion 27 is also provided with a cam 31 which is composed of a convex portion 28 and a concave portion 29 formed in the outer periphery thereof. The internal gear portion 27 is meshed with the small-diameter gear portion 26 of the second gear 22 so that the ring cam 23 rotates at a reduction ratio of Z₃/Z₄ relative to the second gear 22 according to the rotation of the second gear 22.

The winding state detection mechanism 17 detects the winding state of the webbing 2 onto the spool 14. Here, in this embodiment, the detection of the winding state is carried out to determine the wearing of the webbing. That is, whether or not the necessary amount of the webbing 2 for the wearing of the webbing is unwound is determined by detecting the winding state of the webbing 2 onto the spool 14.

The winding state detection mechanism 17 is composed of a combination of the reduction mechanism 16 with a signal output device 32. The signal output device 32 includes an actuator 33 (unwound amount detection device) and a limit switch 34. The actuator 33 has a contact end 35 at one end side and a pivot end 36 at the other end side and is allowed to elastically pivot about the pivot end 36 in a state that the contact end 35 is pressed against the cam portion 31 of the ring cam 23. The actuator 33 functions to transmit a cam action by the cam portion 31 of the ring cam 23 to the limit switch 34. More specifically, the actuator 33 in its initial state, as will be described later, is in contact with the limit switch 34 because the contact end 35 is pressed against the convex portion 28 of the cam portion 31 of the ring cam 23. As the ring cam 23 rotates for a predetermined amount from this state, the contact end 35 is pressed against the concave portion 29 of the cam portion 31, whereby the actuator 33 is spaced apart from the limit switch 34. Accordingly, the limit switch 34 carries out its switching action, that is, the limit switch 34 outputs a winding state detection signal to the outside through a signal transmitting wiring 37.

The ALR mechanism 18 is a mechanical element for locking the webbing 2 from being unwound, i. e. locking the spool 14 from rotating, after the webbing 2 is unwound by a predetermined amount and is composed of a combination of the reduction mechanism 16 with a locking device 41. The locking device 41 includes a lock plate 42 and a lock lever 43. The lock plate 42 is formed in a disc shape and is assembled to the ring cam 23 allowing rotations relative to the ring cam 23 within a predetermined range. That is, the lock plate 42 is assembled to the ring cam 23 in such a manner that the lock plate 42 rotates together with the ring cam 23 in a state that the ring cam 23 rotates over the range allowing the relative rotations. The lock plate 42 is provided with a cam portion 44 formed in its outer periphery. By the rotations of the lock plate 42 according to the rotations of the ring cam 23, the cam portion 44 provides a cam action to the lock lever 43.

The lock lever 43 has a pivot portion 45, a cam action receiving portion 46, and an engaging portion 47 and is allowed to pivot about the pivot portion 45. The lock lever 43 is biased by a spring (not shown) in such a manner so as to press the cam action receiving portion 46 against the cam portion 44 of the lock plate 42. When the cam action receiving portion 46 receives the cam action from the cam portion 44 of the lock plate 42, the engaging portion 47 is engaged with a lock gear (not shown). By the engagement of the engaging portion 47 with the lock gear, the spool 14 is locked from rotating so as to lock the webbing 2 from being unwound. Such mechanism may be a known mechanism disclosed in Japanese Unexamined Patent Application Publication No 2003-191822, for example.

Hereinafter, the actions of the winding state detection mechanism 17 and the ALR mechanism 18 will be described. First, the action of the winding state detection mechanism 17 will be described. In the initial state where the webbing 2 is fully wound onto the spool 14 before the occupant wears the seat belt, the ring cam 23 is in a state that the concave portion 29 of the cam portion 31 is placed at a position apart from the contact end 35 of the actuator 33 by a certain distance and the actuator 33 is in a state that the contact end 35 is pressed against the convex portion 28 of the cam portion 31 of the ring cam 23. As the webbing 2 is withdrawn from this state, the spool 14 rotates in the counter-clockwise direction in FIG. 4. By the rotation of the spool 14, the first gear 21 rotates in the same direction and at the same revolution as the spool 14. Accordingly, the second gear 22 rotates in the clockwise direction at a reduction ratio Ra=Z₁/Z₂ relative to the rotation of the first gear 21, i.e. the rotation of the spool 14 and, further, the ring cam 23 rotates in the clockwise direction at a reduction ratio Rb=Z₃/Z₄ relative to the rotation of the second gear 22, i.e. a reduction ratio Rc=Ra×Rb relative to the rotation of the spool 14.

Here, the reduction ratio Rc of the ring cam 23 relative to the spool 14 is set such that the ring cam 23 does not rotate for a full one circle even when the webbing 2 is withdrawn by the predetermined amount, specifically, the webbing 2 is withdrawn by a necessary amount of the webbing for the occupant to wear the webbing in the predetermined state. In this embodiment, for example, the reduction ratio Ra is set to be about 0.325, the reduction ratio Rb is set to be about 0.185, and the reduction ratio Rc is set to be about 0.06.

As the withdrawal of the webbing 2 accompanying the rotation of the ring cam 23 is conducted for the aforementioned predetermined amount, the contact end 35 of the actuator 33 pressing the convex portion 28 is brought to press the concave portion 29. As a result, the actuator 33 is spaced apart from the switching contact of the limit switch 34 as mentioned above, whereby the limit switch 34 outputs a winding state detection signal. In this manner, the detection of the winding state is carried out.

On the other hand, as the webbing 2 is wound up when the contact end 35 of the actuator 33 presses the concave portion 29, the spool 14 through the ring cam 23 rotates in directions opposite to the aforementioned directions, respectively. Accordingly, the contact end 35 of the actuator 33 pressing the concave portion 29 is brought to press the convex portion 28 again. In this state, the winding state is not detected.

Now, the action of the ALR mechanism 18 will be described. In the aforementioned initial state, the engaging portion 47 of the lock lever 43 is not engaged with the aforementioned lock gear. As the webbing 2 is withdrawn by the predetermined amount accompanying the rotation of the spool 14 through the ring cam 23 as mentioned above from the initial state, the lock lever 43 receives the cam action from the cam portion 44 of the lock plate 42 so as to engage the engaging portion 47 with the aforementioned lock gear, thereby locking the spool 14 from rotating.

On the other hand, as the webbing 2 is wound when the spool 14 is locked from rotating as mentioned above, the spool 14 through the ring cam 23 rotates in the directions opposite to the aforementioned directions, respectively. Accordingly, the engaging portion 47 is disengaged from the aforementioned lock gear, thereby cancelling the locking of the rotation of the spool 14.

In the seat belt retractor 3 as mentioned above, the detection of the winding state of the webbing 2 is conducted by the winding state detection mechanism 17 based on the rotation amount of the spool 14, thereby achieving high accuracy detection. The reduction mechanism 16 as the main mechanical element of the winding state detection mechanism 17 is composed of only three components, i.e. the first and second gears 21, 22 and the ring cam 23, thereby achieving reduction in the number of parts and low cost structure. Further, the reduction mechanism 16 is shared also for the ALR mechanism 18, thereby achieving significant reduction in the number of parts as the whole seat belt retractor 3 and thus achieving further low cost structure.

When the aforementioned function by the ALR mechanism 18, i.e. the function of locking the webbing 2 from being unwound after the webbing 2 is unwound by the predetermined amount, is not required, the lock lever 43 may be omitted so that the first gear 21, the second gear 22, and the ring cam 23 are used as only components for the winding state detection mechanism 17, for example. Since, also in this case, the winding state detection mechanism 17 is composed of only three components, i.e. the first and second gears 21, 22, and the ring cam 23, this case also provides the effect of reduction in the number of parts and thus achieves low cost structure.

Though the present invention has been described with reference to one of embodiments, the present invention is not limited thereto and can be carried out in various forms without departing from the scope of the invention.

The disclosure of Japanese Patent Application No. 2006-271982 filed on Oct. 3, 2006 is incorporated as a reference.

While the invention has been explained with reference to the specific embodiments of the invention, the explanation is illustrative and the invention is limited only by the appended claims.

What is claimed is:

1. A seat belt retractor, comprising:
a winding device for winding and unwinding a webbing by rotation, said winding device having a rotary shaft; and
a winding state detection mechanism for detecting a winding state of said webbing onto said winding device,
wherein said winding state detecting mechanism comprises a first gear connected to the rotary shaft of said winding device; a second gear having a first gear portion meshing with said first gear and a second gear portion having a number of teeth smaller than that of said first gear portion; a ring cam formed in a ring shape and having an internal gear portion, formed in an inner periphery thereof, meshing with the second gear portion of said second gear and having a cam portion formed in an outer periphery thereof; and a signal output device which receives a cam action of said ring cam to output a signal.

2. A seat belt retractor according to claim 1, wherein said winding state detection mechanism has an unwound amount detecting device for detecting an unwound amount of said webbing, said signal output device outputting a signal according to a detection result of said unwound amount detecting device.

3. A seat belt retractor according to claim 1, further comprising an ALR mechanism for locking said webbing from being unwound after said webbing is unwound by a predetermined amount, wherein the first gear, the second gear, and the ring cam of said winding state detection mechanism function also as components of said ALR mechanism.

4. A seat belt retractor according to claim 3, wherein said signal output device is a switch operated by the first gear, the second gear, and the ring cam as the components of said ALR mechanism.

5. A seat belt retractor according to claim 3, wherein said ALR mechanism includes a lock plate formed on the ring cam, and a lock lever actuated by the lock plate and having an engaging portion for engaging a lock gear.

6. A seat belt apparatus comprising:
the seat belt retractor according to claim 1;
a webbing to be wound and unwound by said seat belt retractor;
a tongue disposed on said webbing; and
a buckle device to be latched by said tongue.

7. A vehicle occupant detection device for detecting whether or not a vehicle occupant wears a seat belt, comprising:
a winding device for winding and unwinding a webbing by rotation, said winding device having a rotary shaft; and
a winding state detection mechanism for detecting the winding state of said webbing onto said winding device,
wherein said winding state detecting mechanism comprises a first gear connected to the rotary shaft of said winding device; a second gear having a first gear portion meshing with said first gear and a second gear portion having number of teeth smaller than that of said first gear portion; a ring cam formed in a ring shape and having an internal gear portion, formed in an inner periphery thereof, meshing with the second gear portion of said second gear and having a cam portion formed in an outer periphery thereof; and a signal output device which receives a cam action of said ring cam to output a signal.
